(19) United States
(12) Patent Application Publication
(10) Pub. No.: US 2003/0220896 A1
(43) Pub. Date: Nov. 27, 2003

(54) Method and apparatus for deferred sorting via tentative latency

(76) Inventors: Mark A. Gaertner, Vadnais Heights, MN (US); Mark A. Heath, Oklahoma City, OK (US)

Correspondence Address: Theodore M. Magee, WESTMAN CHAMPLIN & KELLY, International Centre - Suite 1600, 900 South Second Avenue, Minneapolis, MN, 55402-3319, US

(21) Appl. No.: 10/247,862

(22) Filed: Sep. 20, 2002

Related U.S. Application Data
(60) Provisional application No. 60/383,054, filed on May 23, 2002.

(51) Int. Cl. G06F 7/00

(52) U.S. Cl. 707/1

(57) ABSTRACT

A method and apparatus are provided for scheduling commands. A tentatively scheduled command is selected from a command queue for execution. An extended scheduling period, which represents a portion of a time between when a running command is completed and the tentatively scheduled command is scheduled to begin, is then determined. During the extended scheduling period, it is determined that a newly arriving command outperforms the tentatively scheduled command. As a result, the newly arriving command replaces the tentatively scheduled command.

### CROSS-REFERENCE TO RELATED APPLICATION

This application claims priority from U.S. Provisional Application 60/383,054 filed on May 23, 2002 for inventors Mark A. Gaertner and Mark A. Heath and entitled DEFERRED SORTING VIA TENTATIVE LATENCY.

### FIELD OF THE INVENTION

The present invention relates generally to a data storage device. In particular, the present invention relates to a method and apparatus of scheduling commands for disc drives.

### BACKGROUND OF THE INVENTION

Disc drives are widely used data storage devices for computer systems. In a disc drive, data is stored in concentric tracks on one or more discs. The data is accessed by moving a read/write head radially across the disc while rotating the disc below the head. The head is moved based on an address for a read or write command that indicates the sector, or angular position, where the command is to be executed, and the cylinder, or radial position, where the command is to be executed.

The process of reading data from or writing data to a particular memory sector is initiated by a host system, which issues a command to the disc drive across a bus using a defined protocol. Many interface protocols, such as the Small Computer System Interface (SCSI) protocol and ATA protocol, allow multiple commands to be queued at the disc drive.

Such queuing allows the disc drive to optimize a performance characteristic such as access time or response time by intelligently selecting the next command to be executed based on the current position of the head and/or one or more properties of the command. For example, to improve access time, the disc drive would select the command that has the shortest access time relative to the ending position of a currently running command.

In order to prevent the disc drive from being idle, the next command to be executed is scheduled while a running command is currently in execution. To improve the performance of this scheduling, the prior art has waited to select the next command until the currently executing command has nearly finished execution. The reason for this is that it provides more opportunity for commands to be added to the queue and thereby produces more commands to search through. This increases the chance that the best possible command will be found in the queue.

According to traditional algorithms, once a command is scheduled for execution, new commands added to the queue will not be considered for scheduling until the scheduled command nears completion. Thus, the scheduling of a command is treated as one-time event that cannot be overridden. Even if a better command is received before the scheduled command begins execution, the scheduled command cannot be replaced by the better command under the prior art.

Therefore, a method and apparatus for a disc drive that improves command scheduling and disc drive performance by better utilizing access times associated with scheduled commands is needed. The present invention provides a solution to these and other problems, and offers other advantages over the prior art.

### SUMMARY OF THE INVENTION

A method and apparatus are provided for scheduling commands. A tentatively scheduled command is selected from a command queue for execution. An extended scheduling period, which represents a portion of a time between when a running command is completed and the tentatively scheduled command is scheduled to begin, is then determined. During the extended scheduling period, it is determined that a newly arriving command outperforms the tentatively scheduled command. As a result, the newly arriving command replaces the tentatively scheduled command.

Other features and benefits that characterize embodiments of the present invention will be apparent upon reading the following detailed description and review of the associated drawings.

### BRIEF DESCRIPTION OF THE DRAWINGS

FIG. 1 is an isometric view of a disc drive.

FIG. 2 illustrates a portion of a rotating disc and a read/write head used to access various sectors of the rotating disc to execute different commands.

FIG. 3 is a diagrammatic view of a command queue and a scheduled command queue, which are controlled by the method of the present invention.

FIGS. 4 and 5 are flow charts showing the method of one embodiment of the present invention.

FIGS. 6 and 7 are flow charts showing the method of another embodiment of the present invention.

### DETAILED DESCRIPTION OF ILLUSTRATIVE EMBODIMENTS

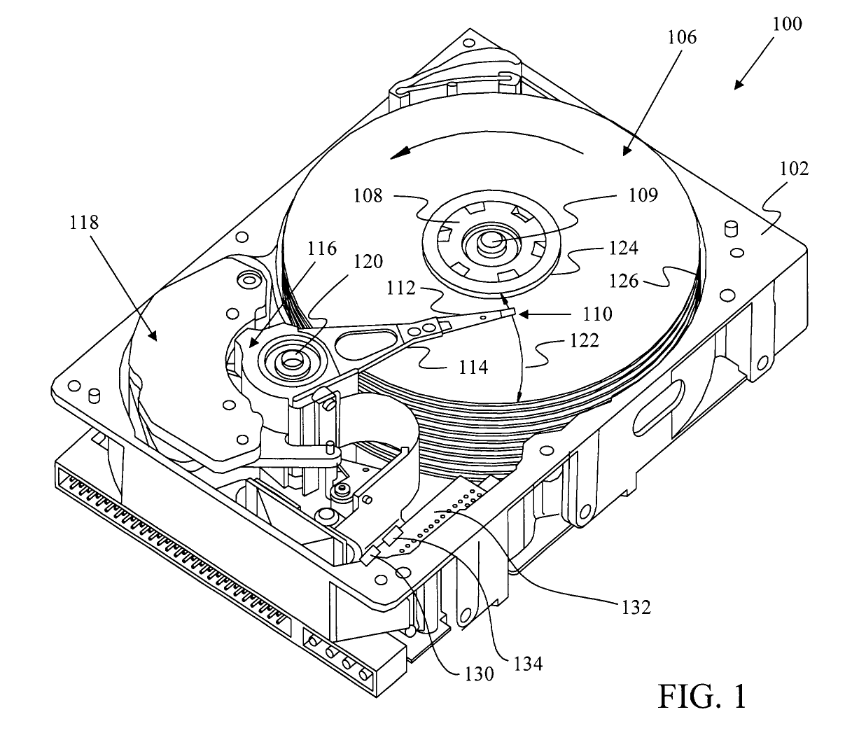

FIG. 1 is an isometric view of a disc drive 100 in which embodiments of the present invention are useful. Disc drive 100 includes a housing with a base 102 and a top cover (not shown). Disc drive 100 further includes a disc pack 106, which is mounted on a spindle motor (not shown) by a disc clamp 108. Disc pack 106 includes a plurality of individual discs, which are mounted for co-rotation about central axis 109. Each disc surface has an associated disc head slider 110, which is mounted to disc drive 100 for communication with the disc surface. Each slider 110 includes at least one head that generates a read signal based on a magnetic pattern stored in the disc surface. This read signal is processed by a read channel (not shown), a type of data receiver, to identify data represented by the magnetic pattern.

In the example shown in FIG. 1, sliders 110 are supported by suspensions 112, which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126.

Voice coil motor 118 is driven by device electronics 132 based on signals generated by heads 110 and a host system (not shown). The host system could be a personal computer in which the disc drive 100 is installed as a data storage device. Device electronics 132 receives commands from the host system that require the read/write head to read or write data at a particular sector and cylinder on the disc surface. In response to the commands, device electronics 132 controls actuator 116 to radially move the read/write head to the appropriate cylinder. Disc rotation then moves the particular sector under the read/write head.

Under some embodiments of the present invention, device electronics 132 includes a servo controller 134 for processing information from the head and moving the actuator and a command controller 130 for handling commands from the host and scheduling commands for execution.

Under embodiments of the present invention, controller 130 receives commands faster than the read/write head executes them. Commands that have not been executed are stored in a command queue. While a running command is in execution, controller 130 examines each command in the command queue and selects one of the commands as a tentatively scheduled command that will be executed after the current running command is completed. Although the tentatively scheduled command has been selected, it may be replaced by a newly arriving command before it begins execution if the newly arriving command performs better than the tentatively scheduled command. Better performance can be measured in many ways such as shorter access time, thereby improving command throughput, better response time, thereby giving preference to older commands, or information priority, thereby giving preference to commands marked as having priority by the host. By providing the opportunity to replace the tentatively scheduled command with a newly arriving command, the present invention effectively increases the size of the command queue that is searched for the next command to execute, thereby increasing the performance of the disc drive.

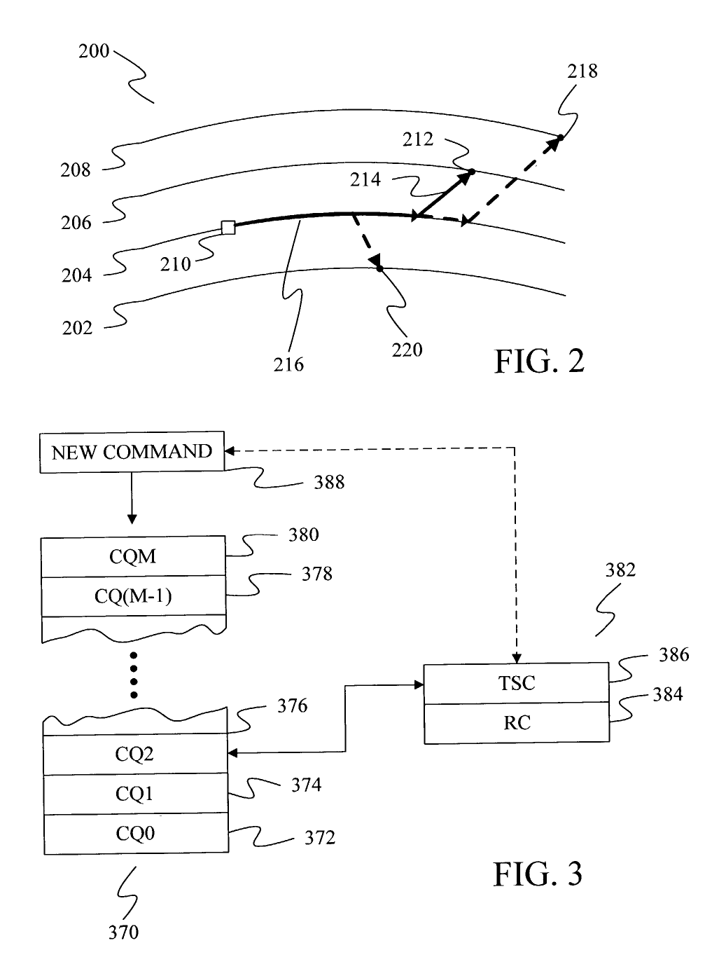

FIG. 2 illustrates how the present invention can increase command throughput by using a tentatively scheduled command. Disc 200 has four cylinders 202, 204, 206 and 208 on its surface. Read/write head 210 has finished executing a command and is waiting to reach a tentatively scheduled command that begins at data sector 212 of cylinder 206. The estimated access time from the current location of read/write head 210 to sector 212 is composed of a tentative seek time 214 and a tentative latency time 216. The tentative seek time 214 is the time required for read/write head 210 to move radially from cylinder 204 to cylinder 206. The tentative latency time 216 is the time needed to move the head from its current angular position on the disc to the angular position of the sector associated with the beginning of the tentatively scheduled command minus the tentative seek time.

Under the prior art, new commands received during the access time could not replace the tentatively scheduled command. Under the present invention, newly arriving commands are compared with the tentatively scheduled command for better performance until the tentative latency time expires. If a newly arriving command does not outperform the tentatively scheduled command, the newly arriving command is stored in the command queue. However, if the newly arriving command performs better than the tentatively scheduled command, the newly arriving command replaces the tentatively scheduled command and the tentatively scheduled command is placed back in the command queue.

For example, with reference to FIG. 2, a newly arriving command begins at sector 218 of cylinder 208. Because the access time from the location of read/write head 210 to sector 218 is longer than the sum of tentative seek time 214 and tentative latency time 216, the tentatively scheduled command outperforms the newly arriving command using the shortest access time criteria. As a result, the tentatively scheduled command remains waiting for execution, and the newly arriving command is stored in the command queue. As a further example, during tentative latency time 216, the disc drive receives another newly arriving command that begins at sector 220 of cylinder 202. Because the access time from the location of read/write head 210 to sector 220 is shorter than the sum of tentative seek time 214 and tentative latency time 216, the newly arriving command outperforms the tentatively scheduled command. As a result, the tentatively scheduled command is replaced by the newly arriving command. The previous tentatively scheduled command is placed back in the command queue to wait for another tentative scheduling.

FIG. 3 schematically illustrates how the command queue interacts with a newly arriving command. Command queue 370 has a variable number of commands from CQO through CQM stored in positions 372, 374, 376, 378 and 380. A running command is stored at position 384 of a scheduled command queue 382 along with a tentatively scheduled command TSC 386 that has been selected from command queue 370 according to a predetermined algorithm based on some desired performance characteristic. As noted above, the algorithm could be based upon access time, response time, information priority, etc. Tentatively scheduled command TSC 386 is waiting for execution after the running command is completed. During the tentative latency time associated with the tentatively scheduled command, a new command 388 arrives and is compared with the tentatively scheduled command 386 for better performance according to the predetermined algorithm. If the tentatively scheduled command outperforms the new command, the new command is placed in command queue 370. If the new command outperforms the tentatively scheduled command, the new command replaces the tentatively scheduled command. Meanwhile, the previous tentatively scheduled command is placed back in command queue 370.

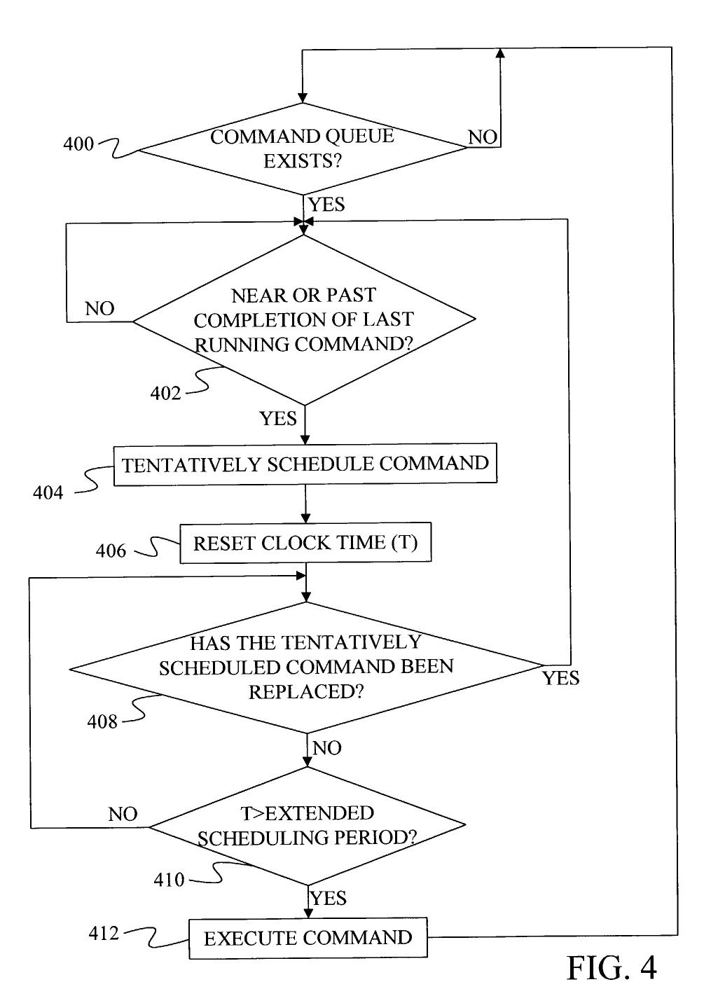

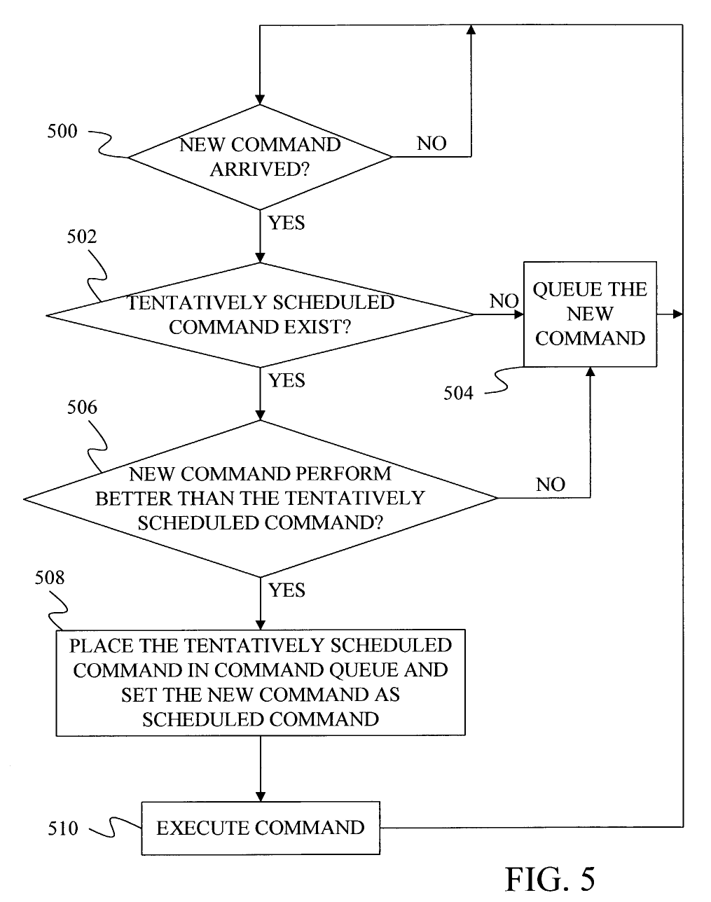

FIGS. 4 and 5 provide flow diagrams of one embodiment of the present invention for scheduling and executing commands in which a tentatively scheduled command is only allowed to be replaced once. FIG. 4 shows a flow diagram that governs the operation of the command queue. FIG. 5 shows a flow diagram that governs the handling of new commands. Both routines have variables in common for their communication. Although shown as two separate routines, those skilled in the art will recognize that the two routines could also be configured as a single routine that is capable of replacing a tentatively scheduled command with an outperforming new command.

Referring to FIG. 4, at the step 400, the routine determines whether a command queue exists. If there is no command queue, step 400 repeats until a command queue exists. When a command queue exists at step 400, the routine proceeds to step 402.

At step 402, the routine checks whether the running command is near completion. If the running command is not close to completion, step 402 repeats until the routine determines that the running command is near completion. If the running command is near completion, the routine proceeds to step 404 and tentatively schedules a command from the command queue for execution.

According to steps 402 and 404, the routine will not tentatively schedule a command until the running command is near completion. This allows the command queue to receive more commands before the routine tentatively schedules a command from the command queue. By waiting, the size of the command queue is given a chance to increase. This improves the performance of the disc drive because there are more commands to select from. It is however noted that step 402 can be omitted in order to achieve other design goals, such as to save CPU resources, without jeopardizing the spirit of the present invention.

At step 406, the routine resets a clock time T that is always running to show the time consumed since the latency time of the current tentatively scheduled command began. At step 408, the routine determines whether the tentatively scheduled command has been replaced by a new command.

This can occur through the process of FIG. 5 as discussed below. If the tentatively scheduled command has been replaced, the routine returns to step 402 because the command that replaced the tentatively scheduled command will be set as the running command and the process of waiting to make a decision on the next tentatively scheduled command will begin again. If the tentatively scheduled command has not been replaced, the routine proceeds to step 410.

At step 410, the time T is compared to an extended scheduling period, which represents a portion of the time between when a last running command is completed and when the tentatively scheduled command is scheduled to begin. Under one embodiment, the extended scheduling period is equal to the latency time L_{T} associated with the tentatively scheduled command, which is equal to the time needed to rotate the disc from the end of the last running command to the beginning of the tentatively scheduled command less the seek time needed to move the read/write head from the cylinder of the last running command to the cylinder of the tentatively scheduled command.

Theoretically, in order to maximize the command throughput, the routine should wait exactly until the tentative latency time L_{T} expires. However, in reality, the read/write head might miss the corresponding cylinder of the tentatively scheduled command during the first attempt to position the head. In such situations, the read/write head will have to wait for another revolution to access the sector. To avoid this, other embodiments of the invention provide a buffer time C that is based upon conditions like microprocessor overhead, mechanical sensitivity and error tolerance, to ensure that the read/write head accesses the sector of the tentatively scheduled command without requiring another revolution of the disc. Thus, in these other embodiments, the extended scheduling period is equal to an adjusted latency time, which is equal to the latency time less the buffer time C.

At step 410, if the clock time T is not greater than the extended scheduling period, the routine returns to step 408. This provides more time for additional better performing commands to be received and selected as the next command to execute. If the clock time T is greater than the extended scheduling period, the routine proceeds to step 412 where the tentatively scheduled command is finally scheduled for execution. At this point, the seek operation is performed to place the read/write head at the appropriate cylinder for the command. After the tentatively scheduled command becomes a running command at step 412, the routine returns to step 400 and repeats the aforementioned steps.

FIG. 5 illustrates a routine for handling new commands that works in cooperation with the routine of FIG. 4. At step 500, the routine determines whether a new command has arrived. If there is no new command, step 500 repeats until a new command arrives. If there is a new command, the routine proceeds to step 502.

At step 502, if a tentatively scheduled command does not exist, the new command is stored in the command queue at step 504 and the routine returns to step 500. This provides step 404 of FIG. 4 with an additional command to consider when selecting the tentatively scheduled command. If a tentatively scheduled command exists at step 502, the routine proceeds to step 506 where the routine determines whether the new command outperforms the tentatively scheduled command. If the new command does not outperform the tentatively scheduled command, the routine stores the new command in the command queue at step 504. If the new command does perform better than the tentatively scheduled command, the routine proceeds to step 508.

In order to determine which command performs better, an algorithm is applied to the two commands. A popular school of algorithms is based upon the access time of the tentatively scheduled command and the new command. This school of algorithms determines the access time for the new command and the tentatively scheduled command to see which one is shorter. The one with the shorter access time is the one that performs better. It is however noted that the spirit of the invention is not limited to algorithms based upon access time. Algorithms based upon different factors, such as response time and the information priority, could also be used without jeopardizing the spirit of the invention.

At step 508, the routine places the previous tentatively scheduled command back on the command queue and sets the new command as a fully or permanently scheduled command, which will be executed at step 510 without yielding to any subsequently arriving commands. Once the command is set for execution the routine returns to step 500.

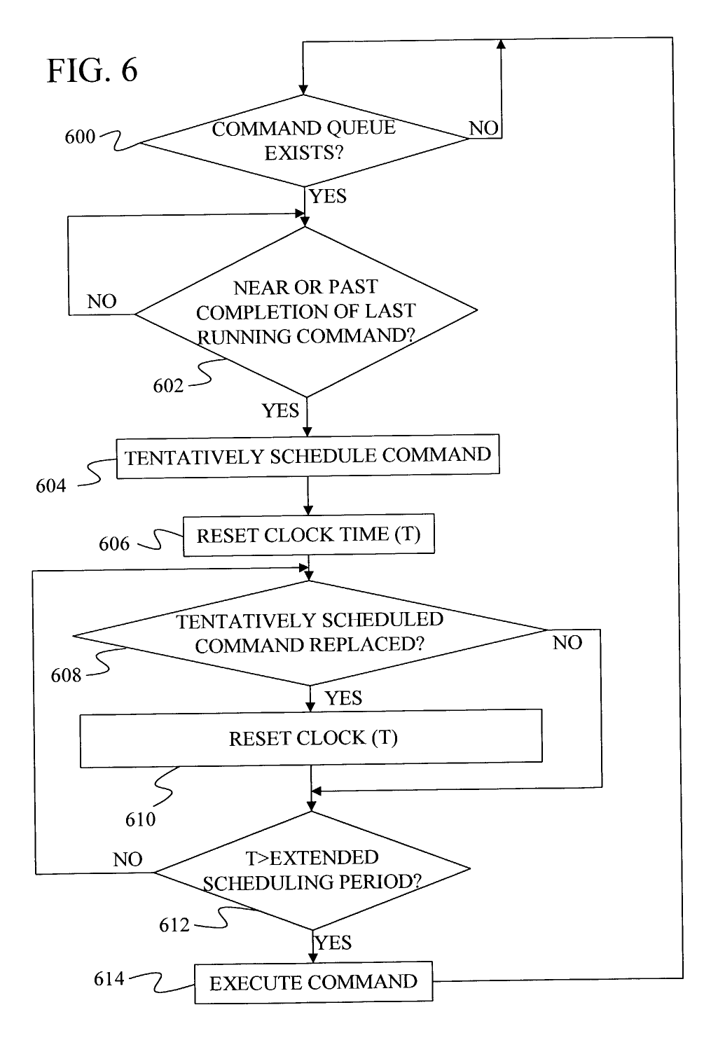

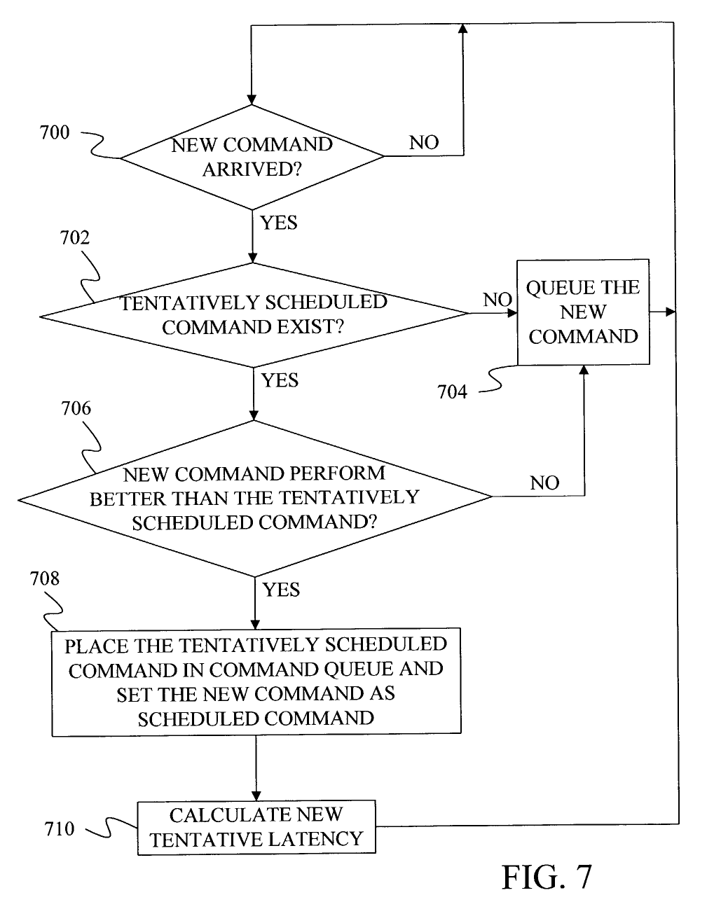

FIGS. 6 and 7 illustrate another embodiment of the present invention, in which tentatively scheduled commands may be repeatedly replaced. FIG. 6 shows a routine for handling the command queue. At step 600, if the command queue exists, the routine proceeds to step 602. If the command queue does not exist, step 600 repeats until the command queue exists.

At step 602, if the running command is near completion, the routine proceeds to step 604 and tentatively schedules a command. If the running command is not near completion, step 602 repeats until the running command is near completion. It is however noted that step 602 could be omitted without jeopardizing the spirit of the present invention.

After tentatively scheduling a command at step 604, the routine continues at step 606 where a clock time T showing the time consumed since the beginning of the latency time of the tentatively scheduled command is reset. At step 608, if the tentatively scheduled command has been replaced through the process shown in FIG. 7, the process continues at step 610 where the clock T is reset. This is done because as part of replacing the tentatively scheduled command, the process of FIG. 7 also recalculates the extended scheduling period based on the latency period associated with the new tentatively scheduled command. As a result of the start of a new extended scheduling period, the clock T must be reset to make the comparison between T and the extended scheduling period meaningful.

After step 610 or if the tentatively scheduled command has not been replaced at step 608, the routine continues at step 612 where the clock time is compared to the extended scheduling period. If T is less than the extended scheduling period, the routine returns to step 608 to determine if the tentatively scheduled command has been replaced. If the clock time T is greater than the extended scheduling period, the current tentatively scheduled command is executed at step 614.

By allowing the tentatively scheduled command to be replaced several times until the extended scheduling period of one of the tentatively scheduled commands expires, steps 608 through 612 provide more opportunity for selecting a command that will improve performance.

FIG. 7 illustrates a routine for handling new commands that works in cooperation with the routine of FIG. 6. At step 700, if there is a new command, the routine proceeds to step 702. If there is no new command, step 700 repeats until a new command arrives.

At step 702, if no tentatively scheduled command exists, the routine queues the new command at step 704 and returns to step 700. If there is a tentatively scheduled command, the routine proceeds to step 706.

At step 706, if the new command does not perform better than the tentatively scheduled command, the routine queues the new command at step 704 and returns to step 700. If the new command outperforms the tentatively scheduled command, the routine places the previous tentatively scheduled command in the queue and sets the new command as the new tentatively scheduled command at step 708. The routine then calculates a new tentative latency time L_{T} and new extended scheduling period for the new command at step 710 by using the sector and cylinder information for the new command. The process then returns to step 700.

In summary, the invention discloses a method of scheduling commands for a data storage device. A command is selected from a command queue 370 as a tentatively scheduled command 386. An extended scheduling period, which represents a portion of a time between when a running command 384 is completed and the tentatively scheduled command 386 is scheduled to begin 212, is determined. During the extended scheduling period, the tentatively scheduled command 386 is replaced with a newly arriving command 388, when newly arriving command 388 outperforms the tentatively scheduled command 386.

The invention further discloses a data storage device that includes a command queue 370 and a controller 130. The command queue 370 includes a list of commands to be executed. Controller 130 is capable of selecting a command from the command queue 387 as a tentatively scheduled command 386 and determining an extended scheduling period between when a running command 384 is completed and the tentatively scheduled command 386 is scheduled to begin. The controller 130 is further capable of replacing the tentatively scheduled command 386 with another command 388 during the extended scheduling period.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the disc drive system while maintaining substantially the same functionality without departing from the scope and spirit of the present invention. For example, the disc drive may include a single disc or multiple discs, disc with magnetic media on one or both disc sides, and optical discs. In addition, the teachings of the present invention can be applied to other data storage systems, like tape drives or solid-state memory, without departing from the scope and spirit of the present invention.

What is claimed is:

1. A method of scheduling commands for a data storage device, the method comprising:
a) selecting a command from a command queue as a tentatively scheduled command;
b) determining an extended scheduling period representing a portion of a time between when a running command is completed and the tentatively scheduled command is scheduled to begin;
c) during the extended scheduling period, determining that a newly arriving command outperforms the tentatively scheduled command; and
d) replacing the tentatively scheduled command with the newly arriving command.

2. The method of claim 1 wherein the step of selecting a command further comprises waiting to select a command until a running command is substantially completed.

3. The method of claim 1 wherein the step of determining that the newly arriving command outperforms the tentatively scheduled command comprises determining that the newly arriving command has a shorter access time than the tentatively scheduled command.

4. The method of claim 1 wherein the step of determining that the newly arriving command outperforms the tentatively scheduled command comprises determining that the newly arriving command has a better response time than the tentatively scheduled command.

5. The method of claim 1 wherein the step of determining that the newly arriving command outperforms the tentatively scheduled command comprises determining that the newly arriving command has a information priority higher than the tentatively scheduled command.

6. The method of claim 1 wherein the step of determining the extended scheduling period comprises determining a tentative latency time.

7. The method of claim 6 wherein the step of determining the extended scheduling period further comprises determining a buffer time and subtracting the buffer time from the tentative latency time.

8. The method of claim 1 wherein the step of replacing the tentatively scheduled command further comprises:
placing the tentatively scheduled command in the command queue; and
permanently scheduling the newly arriving command for execution.

9. The method of claim 1 wherein the step of replacing the tentatively scheduled command further comprises:
placing the tentatively scheduled command in the command queue;
setting with the newly arriving command as a new tentatively scheduled command;
determining a new extended scheduling period;
during the new extended scheduling period, determining that a subsequently arriving command outperforms the new tentatively scheduled command; and
replacing the new tentatively scheduled command with the subsequently arriving command.

10. A data storage device comprising:
a command queue having a list of commands to be executed; and
a controller capable of:
selecting a command from the command queue as a tentatively scheduled command for execution after a running command is completed;
determining an extended scheduling period between when the running command ends and the tentatively scheduled command is scheduled to begin; and
replacing the tentatively scheduled command with another command during the extended scheduling period.

11. The data storage device of claim 10 wherein the controller comprises an algorithm for determining that the newly arriving command has a shorter access time than the tentatively scheduled command.

12. The data storage device of claim 10 wherein the controller comprises an algorithm for determining that the newly arriving command has a better response time than the tentatively scheduled command.

13. The data storage device of claim 10 wherein the controller comprises an algorithm for determining that the newly arriving command has information priority higher than the tentatively scheduled command.

14. The data storage device of claim 10 wherein the controller replaces the tentatively scheduled command with the other command by placing the tentatively scheduled command in the command queue and permanently scheduling the other command for execution.

15. The data storage device of claim 10, wherein the controller replaces the tentatively scheduled command with the other command by placing the tentatively scheduled command in the command queue and setting the other command as a new tentatively scheduled command.

16. The data storage device of claim 15 wherein the controller is further capable of:
determining a new extended scheduling period based on the new tentatively scheduled command; and
replacing the new tentatively scheduled command with a third command during the new extended scheduling period.

17. An apparatus for scheduling commands to access data in a data storage device, the apparatus comprising:
a command queue providing a list of commands; and
controller means for selecting a command from the command queue as a tentatively scheduled command, for identifying an extended scheduling period between when a last command ends and a tentatively scheduled command is scheduled to begin and for replacing the tentatively scheduled command with a newly arriving command during the extended scheduling period when the newly arriving command outperforms the tentatively scheduled command.

18. The apparatus of claim 17 wherein the extended scheduling period is identified by determining a latency time associated with the tentatively scheduled command.

19. The apparatus of claim 18 wherein the extended scheduling period is further identified by subtracting a buffer time from the latency time.

20. The apparatus of claim 17 wherein the controller means replaces tentatively scheduled commands multiple times after a last command completed execution.
